(19) United States
(12) Patent Application Publication
(10) Pub. No.: US 2011/0316762 A1
(43) Pub. Date: Dec. 29, 2011

(54) ELECTRONIC SYSTEM, METHOD FOR CONTROLING MOBILE APPARATUS, READING APPARATUS AND METHOD FOR CONTORLING THEREOF

(75) Inventors: Su-Cheng LIU, Hsinchu City (TW); Chuang-Chuang TSAI, Hsinchu City (TW); Cheng-Hao LEE, Hsinchu City (TW); Ming-Chuan HUNG, Hsinchu City (TW)

(73) Assignee: E Ink Holdings Inc., Hsinchu (TW)

(21) Appl. No.: 12/870,342

(22) Filed: Aug. 27, 2010

(30) Foreign Application Priority Data
Jun. 28, 2010 (TW) 099121088

(51) Int. Cl. G09G 5/00

(52) U.S. Cl. 345/2.2

(57) ABSTRACT

An electronic system comprises a mobile apparatus and a reading apparatus. The reading apparatus has a display screen and a plurality of operation units. When the reading apparatus is linked with the mobile apparatus through a data-transmission interface, the reading apparatus displays an image of an electronic file on the display screen thereof which is stored in the mobile apparatus. When one of the operation units is enabled, the reading apparatus generates a corresponding operation signal to the mobile apparatus, thus the mobile apparatus performs a corresponding operation process according to the operation signal.

### BACKGROUND

1. Technical Field

The present invention relates to an electronic system, and more particularly to an electronic system configured for reading electronic file.

2. Description of the Related Art

With the development of the semiconductor process technology, the display technology, the industrial design and the communication technology, mobile apparatus is manufactured more and more thin, and the function thereof is more and more powerful. The mobile apparatus may be a small device with operation-processing function, such as mobile phone, smart mobile phone, personal digital assistant and pocket computer, etc.

Currently, the mobile apparatus not only has the common function of calendar, keeping record of event, receiving or sending message, and dialing or answering the phone, but also has the function of wirelessly getting on the Internet, playing game, and being regarded as e-book reading apparatus. For the e-book reading apparatus, since the mobile apparatus is light and thin, the user can read e-books whenever and wherever possible and perform the editing operation thereon if the e-books are stored into the mobile apparatus.

Generally, since the mobile apparatus is the lighter and thinner the better, the size of the display screen thereof is not large. The size of the display screen of the present mobile apparatus in the market is approximately 3.2 inches, 3.5 inches and 3.7 inches. If the user only employs the mobile apparatus to perform the operation of editing the calendar, etc., the above size thereof is enough. However, if the user employs the mobile apparatus to reading the e-book, the display screen with the above size is laborious in use for the user reading the e-book.

### BRIEF SUMMARY

The present invention relates to an electronic system, which makes an user read an electronic file in a cozy mode.

The present invention also relates to a reading apparatus, which makes an user read an electronic file stored in a mobile apparatus.

The present invention further relates to a controlling method for a reading apparatus, which makes the reading apparatus display an electronic file stored in a mobile apparatus, for being read by an user.

In addition, the present invention further relates to a controlling method for a mobile apparatus, which makes the mobile apparatus display an electronic file on a reading apparatus.

An electronic system in accordance with a preferable exemplary embodiment of the present invention comprises a mobile apparatus and a reading apparatus. The reading apparatus has a display screen and a plurality of operation units. When the reading apparatus is linked with the mobile apparatus through a data-transmission interface, the reading apparatus displays an image of an electronic file on the display screen thereof which is stored in the mobile apparatus. When one of the operation units is enabled, the reading apparatus generates a corresponding operation signal to the mobile apparatus, thus the mobile apparatus performs a corresponding operation process according to the operation signal.

In another aspect of the present invention, a reading apparatus is provided that comprises a transceiver module, a display screen and an operation module. The transceiver module is configured for receiving and sending data through a data-transmission interface. The operation module has a plurality of operation units. When the reading apparatus is linked with a mobile apparatus through the data-transmission interface, the reading apparatus displays an image of an electronic file on the display screen which is stored in the mobile apparatus. When one of the operation units is enabled, the operation module outputs a corresponding operation signal to the mobile apparatus through the data-transmission interface by the transceiver module, such that the mobile apparatus performs a corresponding operation process.

In addition, the data-transmission interface is selected from a group consisted of an universal serial bus interface, a Bluetooth transmission interface and an infrared transmission interface.

In another aspect of the present, a controlling method for a reading apparatus is further provided, wherein the reading apparatus has a plurality of operation units. The controlling method comprises: detecting whether the reading apparatus is linked with a mobile apparatus through a data-transmission interface; when the reading apparatus is linked with the mobile apparatus through the data-transmission interface, displaying an image of an electronic file on the reading apparatus which is stored in the mobile apparatus, according to an operation of the user; and when any one of the operation units is enabled, generating a corresponding operation signal to the mobile apparatus, such that the mobile apparatus performs a corresponding operation process.

in another aspect of the present, a controlling method for a mobile apparatus is provided comprising: detecting whether the mobile apparatus is linked with a reading apparatus through a data-transmission interface, wherein the reading apparatus has a plurality of operation units; when the mobile apparatus is linked with the reading apparatus through the data-transmission interface, permitting the reading apparatus to display an image of an electronic file stored in the mobile apparatus; and when any one of the operation units is enabled, generating a corresponding operation signal by the reading apparatus such that the mobile apparatus performs a corresponding operation process according to the operation signal.

Preferably, the operation units comprise a plurality of substantial keys.

In addition, the electronic file is selected from a group consisted of an e-book, a word document, an image document and an email.

The present invention can employ the reading apparatus to display the electronic file stored in the mobile apparatus, and employ the mobile apparatus to respond to the operation signal for performing the corresponding operation process. Therefore, the present invention can make the user read the electronic file in a cozy mode.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block view of an electronic system in accordance with a preferable exemplary embodiment of the present invention.

FIG. 2 is a system block view of a mobile apparatus in accordance with a preferable exemplary embodiment of the present invention.

FIG. 3 is a system block view of a reading apparatus in accordance with a preferable exemplary embodiment of the present invention.

FIG. 4 is a system block view of a reading apparatus in accordance with another preferable exemplary embodiment of the present invention.

FIG. 5 is a step flowing chart of a controlling method for a reading apparatus in accordance with a preferable exemplary embodiment of the present invention.

FIG. 6 is a step flowing chart of a controlling method for a mobile apparatus in accordance with a preferable exemplary embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The principal essence of the present invention is linking a reading apparatus with a mobile apparatus such that the reading apparatus is used as an extending display screen of the mobile apparatus. Therefore, the user can conveniently read electronic file, such as e-book, and edit it.

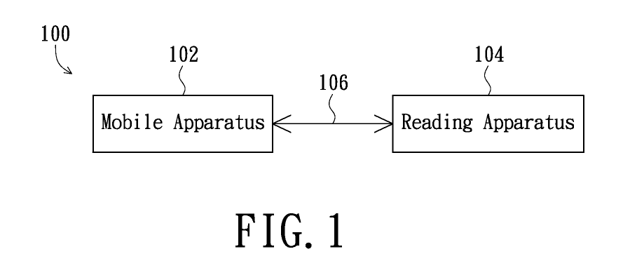

FIG. 1 is a schematic block view of an electronic system in accordance with a preferable exemplary embodiment of the present invention. Referring to FIG. 1 the electronic system 100 of the preferable exemplary embodiment comprises a mobile apparatus 102 and a reading apparatus 104. The mobile apparatus 102 may be a mobile phone, a smart mobile phone, a personal digital assistant, or a pocket computer. In addition, the mobile apparatus 102 is linked with the reading apparatus 104 through a data-transmission interface 106. In some exemplary embodiments, the data-transmission interface 106 is a wire interface, such as the universal serial bus (USB) interface. In other exemplary embodiments, the data-transmission interface 106 also may be a wireless interface, such as the Bluetooth transmission interface or the infrared transmission interface.

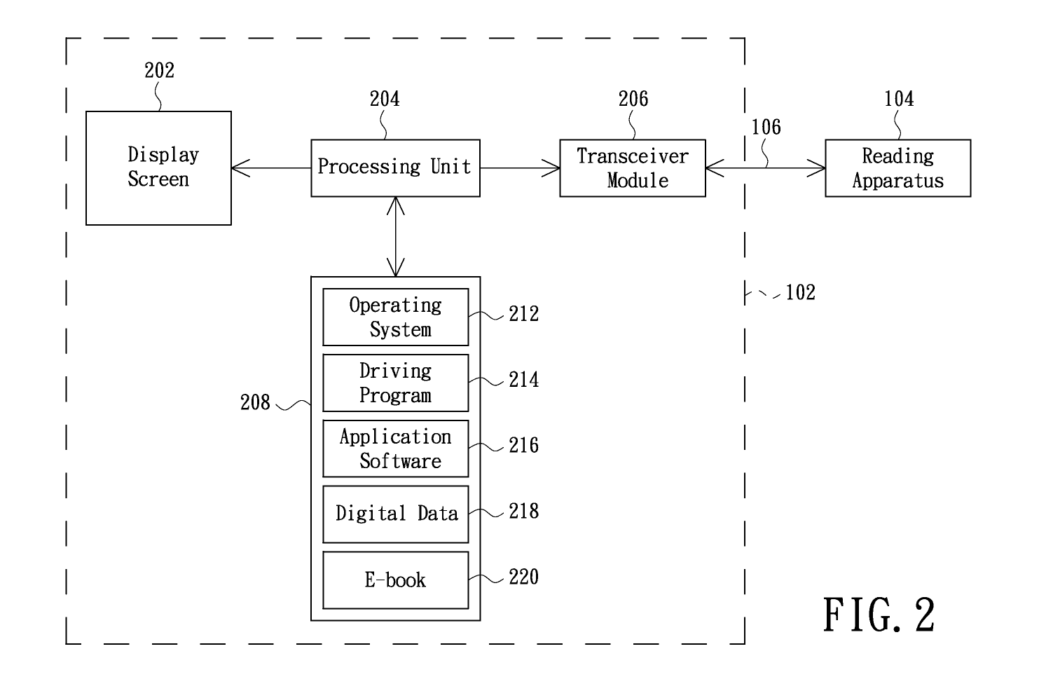

FIG. 2 is a system block view of a mobile apparatus in accordance with a preferable exemplary embodiment. As shown in FIG. 2, the mobile apparatus 102 comprises a display screen 202, a processing unit 204, a transceiver module 206 and a storing unit 208. The processing unit 204 is coupled to the display screen 202, the transceiver module 206 and the storing unit 208. In addition, the transceiver module 206 is linked with the reading apparatus 104 through the data-transmission interface 106.

The storing unit 208 may be an electric volatile memory, such as flash memory. In addition, the storing unit 208 also may be a hard disk. In some preferable exemplary embodiment, the storing unit 208 also may be a memory card. The storing unit 208 may have an operating system 212, a driving program 214 and an application software 216 installed therein. In addition, the storing unit 208 may further store some digital data 218, for example the electronic file, such as word document, image document and email document, etc. In this preferable exemplary embodiment, the storing unit 208 may further store some electronic files, such as e-book 220.

When the mobile apparatus 102 is worked, the processing unit 204 accesses the data in the storing unit 208, and displays a display image on the display screen 202. Specially, when the mobile apparatus 1102 is linked with the reading apparatus 104 through the data-transmission interface 106, the reading apparatus 104 can display the image of the electronic file stored in the mobile apparatus 102.

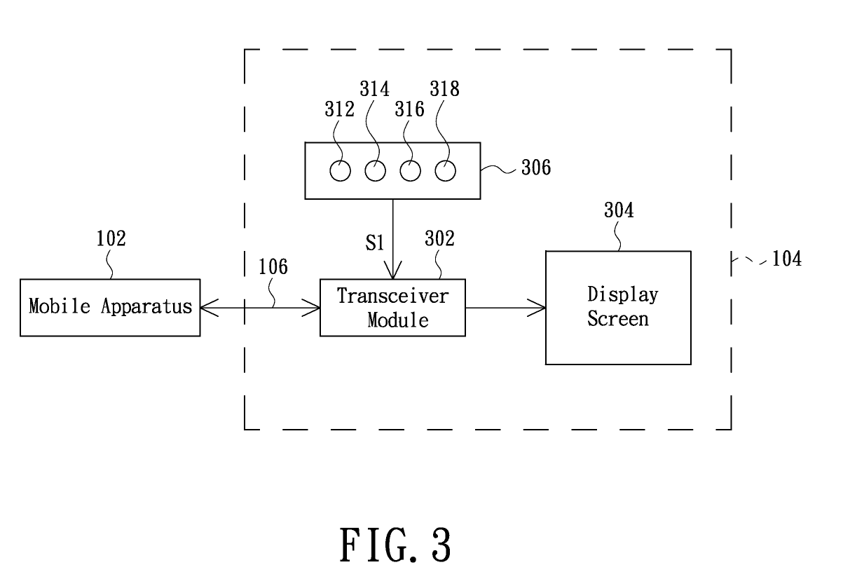

FIG. 3 is a system block view of a reading apparatus in accordance with a preferable exemplary embodiment of the present invention. Referring to FIG. 3, the reading apparatus 104 of the preferable exemplary embodiment comprises a transceiver module 302, a display screen 304 and an operating module 306. The transceiver module 302 is coupled to the data-transmission interface 106, the display screen 304 and the operating module 306.

Referring to FIGS. 2 and 3, when the mobile apparatus 102 is linked with the reading apparatus through the data-transmission interface 106, the mobile apparatus 102 will transmit the image of the electronic file stored in the storing unit 208 to the transceiver module 206. Meanwhile, the transceiver module 206 transmits the obtained image to the reading apparatus 104 through the data-transmission interface 106. The reading apparatus can employ the transceiver module 302 to receive the image of the electronic file from the data-transmission interface 106 to the display screen 304 for displaying the image of the electronic file.

The display screen 304 may be a bistable display, such as the electrophoresis display. This kind of the display still can display the image without supplying the electronic power. Therefore, when the user employs the reading apparatus 104 to display the image of the electronic file, it can effectively reduce the consumption of the electronic power. In addition, the size of the display screen 304 is larger than that of the display screen 202, for example, the size of the display screen 302 is 10 inches. Therefore, the user can read the electronic file in a cozy mode.

On the other hand, the operating module 306 comprises a plurality of operation units, such as 312, 314, 316 and 318. In some exemplary embodiments, the operation units 312, 314, 316 and 318 may be a plurality of substantial keys, and each of the operation units 312, 314, 316 and 318 correspond to different operation functions respectively, such as “previous page”, “next page”, “zooming in”, “zooming out”, “receiving email”, “sending email” and “parallel moving direction” keys, etc. When any one of the operation units 312, 314, 316 and 318 is enabled, the operating module 306 will generate a corresponding operation signal Si to the transceiver module 302. Meanwhile, the transceiver module 302 transmits the operation signal Si to the mobile apparatus 102 through the data-transmission interface 106.

When the operation signal Si is transmitted to the mobile apparatus 102 through the data-transmission interface 106, the transceiver module 206 receives and transmits the operation signal S1 to the processing unit 204. At the moment, the processing unit 204 can perform a corresponding operation process according to the operation signal S1. Therefore, the present invention can employ the operation ability of the processing unit 204 of the mobile apparatus 102 to process the operation signal S1 of the reading apparatus, thus it can decrease or substitute the cost of disposing the processing unit in the reading apparatus 102, and save the consumption of the electronic power of the reading apparatus 102.

For example, when the user reads the e-book on the reading apparatus 104 and presses the operation unit of “next page”, the reading apparatus 104 will generate the corresponding operation signal S1. The processing unit 204 of the mobile apparatus 102 will transmit the display image of the next page of the e-book read by the user to the reading apparatus, to complete the operation action of “next page” for corresponding to the operation signal S1. Furthermore, for the operation signal of “sending email” of the reading apparatus 104, it can employ the function of the email of the mobile apparatus 102 to send the email edited by the user on the reading apparatus 104.

From the above description it can be seen that, when the reading apparatus 104 is linked with the mobile apparatus 102 through the data-transmission interface 106, the processing unit 204 of the mobile apparatus 102 can process and respond to the operation signal of the reading apparatus 104. Therefore, the reading apparatus 104 needs not to have the operation function, thus it can decrease the cost of the hardware. However, in the preferable exemplary embodiment as shown in FIG. 3, when the reading apparatus 104 is broken with the mobile apparatus 102, or when the mobile apparatus have no the electronic power, the reading apparatus cannot still display the image of the electronic file. Therefore, the following will describe the reading apparatus 104 in accordance with another exemplary embodiment of the present invention.

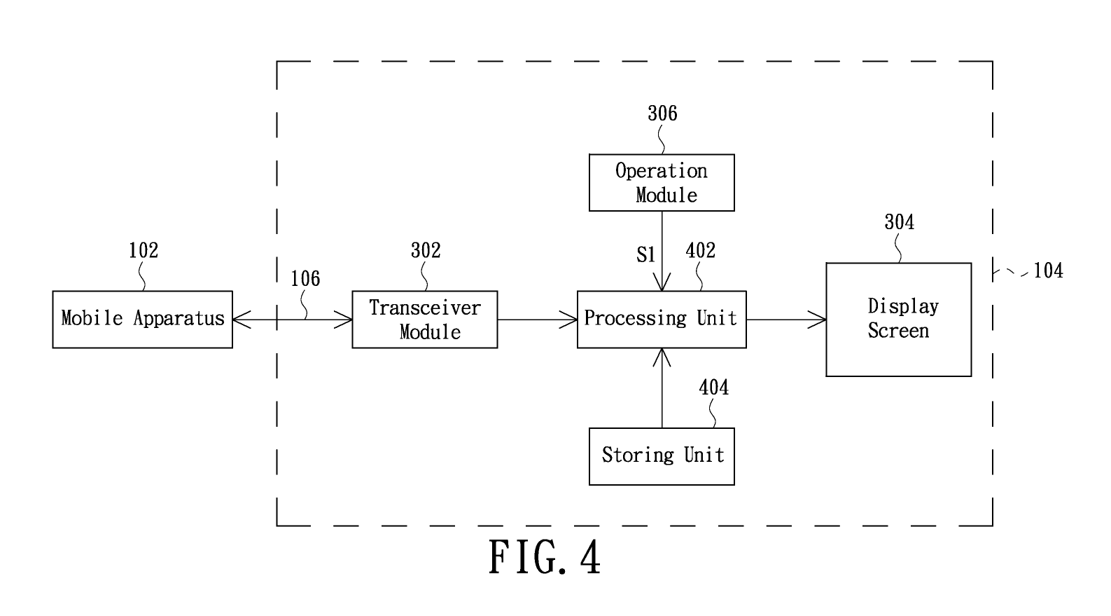

FIG. 4 is a system block view of a reading apparatus in accordance with another preferable exemplary embodiment of the present invention. Referring to FIG. 4, the reading apparatus 104 of the this embodiment further comprises a processing unit 402 and a storing unit 404. The processing unit 402 is coupled to the transceiver module 302, the display screen 304, the operation module 306 and the storing unit 404. When the reading apparatus 104 is not linked with the mobile apparatus 102, the processing unit 402 controlling the reading apparatus 104. For example, when one of the operation units is enabled, the enabled operation unit will output the corresponding operation signal S1 to the processing unit 402 for processing.

However, in the exemplary embodiment, when the reading apparatus 104 is linked with the mobile apparatus 102 through the data-transmission interface 106, the processing unit 402 can be set in an idle state. Therefore, the messages transmitted to the processing unit 402 for being processed, such as the operation signal S1 etc., will be directly transmitted to the transceiver module 302, and then be transmitted to the mobile apparatus 102 through the data-transmission interface 106. The mobile apparatus 102 is employed to response the messages. The detailed description is described in the above, and not detailedly described in following.

In addition, the reading apparatus can obtain the copy of the electronic file stored in the mobile apparatus 102 through the data-transmission interface 106. The copy is stored in the storing unit 404 after being received by the transceiver module 302. Similarly, the storing unit 404 may be a flash memory, a hard disk or a memory card. In the preferable exemplary embodiment, when the reading apparatus 104 is broken with the mobile apparatus 102, or when the mobile apparatus 102 has no the electronic power, the user can operate the reading apparatus 104 to read the image of the electronic file stored in the storing unit 404.

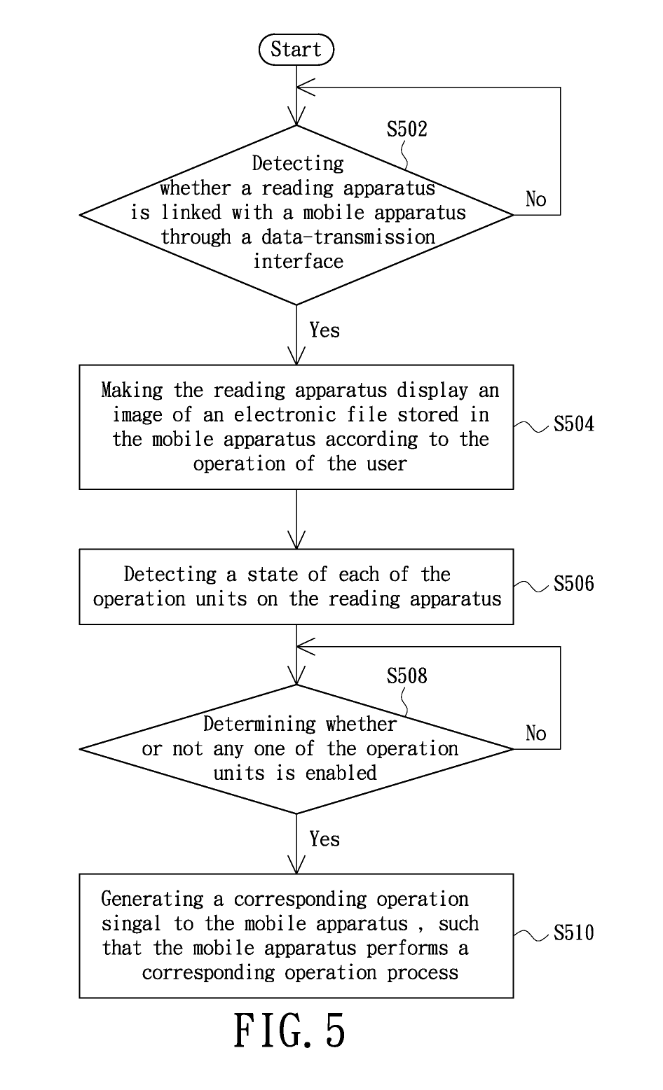

FIG. 5 is a flowing chart of a controlling method for a reading apparatus in accordance with a preferable exemplary embodiment of the present invention. Referring to FIG. 5, the controlling method of the exemplary embodiment may be performed by the software mode, and it can be written into the processing unit 402 or the receiving or sending module 302 of the reading apparatus 104. The controlling method of the exemplary embodiment may firstly comprises detecting whether the reading apparatus is linked with a mobile apparatus (such as the mobile apparatus 102 as shown in FIG. 1) through a data-transmission interface (such as the data-transmission interface 106) as described in a step S502.

When detecting the reading apparatus is linked with the mobile apparatus through the data-transmission interface (that is yes marked by the step S502), a step S504 is performed. That is, the reading apparatus displays the image of the electronic file stored in the mobile apparatus. In addition, the exemplary embodiment may further comprise detecting the state of each of the operation units as described in a step S506 to perform a step S508 of detecting whether any one of the operation units is enabled. When one of the operation units is enabled (that is yes marked by the step S508), a corresponding operation signal is generated to the mobile apparatus such that the mobile apparatus performs a corresponding operation process according to the operation signal as described in a step S510.

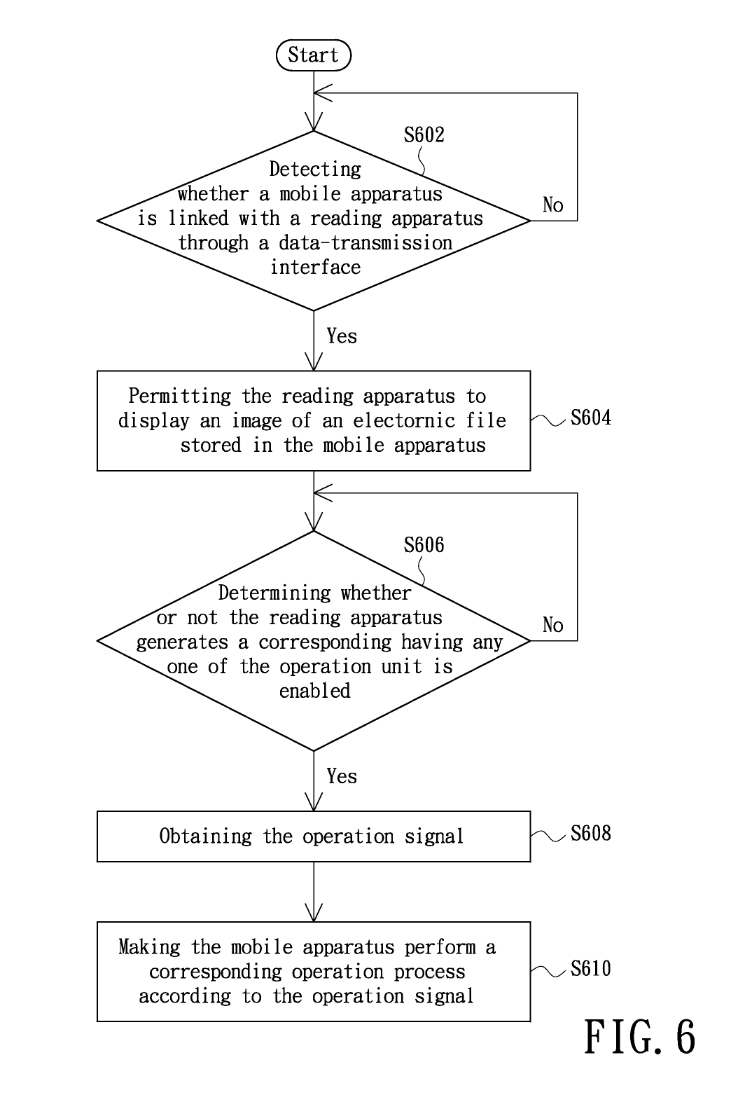

FIG. 6 is a step flowing chart of a controlling method of a mobile apparatus in accordance with a preferable exemplary embodiment of the present invention. Referring to FIG. 6, the controlling method of the exemplary embodiment can be performed by the application software as shown in FIG. 2. In other exemplary embodiments, the controlling method thereof may be written in the processing unit 204 by the firmware mode.

The controlling method of the exemplary embodiment firstly comprises detecting whether the mobile apparatus is linked with a reading apparatus (such as the reading apparatus 104 as shown in FIG. 1) through a data-transmission interface (such as the data-transmission interface 106 as shown in 1) as described in a step S602. When detecting the mobile apparatus is linked with the reading apparatus (that is yes marked by the step S602), a step S604 is performed. That is, the reading apparatus is permitted to display the image of the electronic file stored in the mobile apparatus.

Then, the exemplary embodiment further comprises a step S606 of determining whether or not the reading apparatus generates a corresponding operation signal because one of the operation units is enabled. If the reading apparatus generates the operation signal (that is yes marked by the step S606), a step S608 is performed. That is obtaining the operation signal. Then the mobile apparatus performs a corresponding operation process according to the operation signal as describe in a step S610.

In summary, since the present invention links the reading apparatus with the mobile apparatus through the data-transmission interface, and the mobile apparatus responds to the operation of the reading apparatus, it can decrease or substitute the cost of disposing the processing unit in the reading apparatus and save the consumption of the electronic power of the reading apparatus. At the moment, since the reading apparatus may display the image of the electronic file stored in the mobile apparatus, the user can read the electronic file in a cozy mode.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electronic system, comprising:
a mobile apparatus; and
a reading apparatus, having a second display screen and a plurality of operation units;
wherein when the reading apparatus is linked with the mobile apparatus through a data-transmission interface, the reading apparatus displays an image of an electronic file on the display screen thereof which is stored in the mobile apparatus, and
when one of the operation units is enabled, the reading apparatus generates a corresponding operation signal to the mobile apparatus, thus the mobile apparatus performs a corresponding operation process according to the operation signal.

2. The electronic system as claimed in claim 1, wherein the mobile apparatus is selected from a group consisted of a personal digital assistant, a pocket computer, a mobile phone and a smart mobile phone.

3. The electronic system as claimed in claim 1, wherein the mobile apparatus comprises:
a transceiver module, linked with the reading apparatus through the data-transmission interface; and
a processing unit, coupled to the transceiver module for sending the display image to the reading apparatus through the transceiver module, and receiving the operation signal to respond to the operation signal.

4. The electronic system as claimed in claim 3, wherein the mobile apparatus further comprises a storing unit coupled to the processing unit.

5. The electronic system as claimed in claim 4, wherein the storing unit is selected from a group consisted of a flash memory, a hard disk and a memory card.

6. The electronic system as claimed in claim 1, wherein the second display screen is an electrophoresis display screen.

7. The electronic system as claimed in claim 1, wherein the data-transmission interface is selected from a group consisted of a universal serial bus interface, a Bluetooth transmission interface and an infrared transmission interface.

8. A reading apparatus, comprising:
a transceiver module, transmitting data through a data-transmission interface;
a display screen; and
an operation module, having a plurality of operation units;
wherein when the reading apparatus is linked with a mobile apparatus through the data-transmission interface, the reading apparatus displays an image of an electronic file on the display screen which is stored in the mobile apparatus, and
when one of the operation units is enabled, the operation module output a corresponding operation signal, the operation signal is transmitted to the mobile apparatus through the data-transmission interface by the transceiver module, such that the mobile apparatus performs a corresponding operation process.

9. The reading apparatus as claimed in claim 8, wherein the display screen is an electrophoresis display screen.

10. The reading apparatus as claimed in claim 8, wherein the operation module is coupled to the transceiver module.

11. The reading apparatus as claimed in claim 8, further comprising:
a storing unit, temporarily storing an electronic file originally stored in the mobile apparatus; and
a processing unit, coupled to the display screen, the detecting unit, the transceiver module, the operation module and the storing unit,
wherein when the reading apparatus is not linked with the mobile apparatus, the processing unit is used for controlling the reading apparatus, and
when the reading apparatus is linked with the mobile apparatus through the data-transmission interface, the processing unit enter an idle state, and the operation of the reading apparatus is controlled by the mobile apparatus.

12. The reading apparatus as claimed in claim 11, wherein the storing unit is selected from a group consisted of a flash memory, a hard disk and a memory card.

13. The reading apparatus as claimed in claim 8, wherein the operation units comprise a plurality of substantial keys.

14. The reading apparatus as claimed in claim 8, wherein the data-transmission interface is selected from a group consisted of a universal serial bus interface, a Bluetooth transmission interface and an infrared transmission interface.

15. A controlling method for reading apparatus, adapted for a reading apparatus having a plurality of operation units, the controlling method comprising:
detecting whether or not the reading apparatus is linked with a mobile apparatus through a data-transmission interface;
when the reading apparatus is linked with the mobile apparatus through the data-transmission interface, displaying an image of an electronic file on the reading apparatus which is stored in the mobile apparatus, according to an operation of the user; and
when any one of the operation units is enabled, generating a corresponding operation signal to the mobile apparatus, such that the mobile apparatus performs a corresponding operation process.

16. The controlling method as claimed in claim 15, further comprising:
obtaining a copy of the electronic file through the data-transmission interface from the mobile apparatus; and
storing the copy of the electronic file in the reading apparatus so as to display the image of the electronic file on the reading apparatus even the reading apparatus without linking with the mobile apparatus.

17. The controlling method as claimed in claim 15, wherein the electronic file is selected from a group consisted of an e-book, a word document, an image document and an email.

18. A controlling method for a mobile apparatus, comprising:
detecting whether or not the mobile apparatus is linked with a reading apparatus with a plurality of operation units through a data-transmission interface;
when the mobile apparatus is linked with the reading apparatus through the data-transmission interface, permitting the reading apparatus to display an image of an electronic file stored in the mobile apparatus; and
when any one of the operation units is enabled, generating a corresponding operation signal by the reading apparatus such that the mobile apparatus performs a corresponding operation process according to the operation signal.

19. The controlling method as claimed in claim 18, further comprising: transmitting a copy of the electronic file to the reading apparatus through the data-transmission interface to store the reading apparatus, so as to still display the image of the electronic file on the reading apparatus when the reading apparatus is not linked with the mobile apparatus.

20. The controlling method as claimed in claim 18, wherein the electronic file is selected from a group consisted of an e-book, a word document, an image document and an email.
